(19) United States
(12) Patent Application Publication
(10) Pub. No.: US 2021/0175719 A1
(43) Pub. Date: Jun. 10, 2021

(54) METHOD AND SYSTEM FOR CREATING INFORMATION REPRESENTING A STATE OF AN ELECTRICAL POWER DISTRIBUTION SYSTEM

(71) Applicant: SUN ELECTRIC DIGITAL STREAM LTD., Road Town, Tortola (VG)

(72) Inventor: Matthew Peloso, Singapore (SG)

(21) Appl. No.: 17/052,406

(22) PCT Filed: May 2, 2019
(86) PCT No.: PCT/SG2019/050244

§ 371 Date: Nov. 2, 2020

(30) Foreign Application Priority Data
May 2, 2018 (SG) 10201803684P

(51) Int. Cl. H02J 3/38; G06F 16/27; G05B 15/02; G06F 21/60

(52) U.S. Cl. CPC H02J 3/381; G06F 21/602; G05B 15/02; G06F 16/27

(57) ABSTRACT

A method and system for creating information representing a state of an electrical power distribution system for supply of energy from one or more distributed generators to a target load. The method comprises the steps of determining target consumption data representing energy consumed by the target load; and creating capacity-resolved supply data representing energy supplied to the target load from the one or more distributed generators; wherein creating the capacity-resolved supply data comprises categorizing the energy supplied to the target load into at least one of a first supply category and a second supply category, the first supply category being supply equal to or less than the energy consumed by the target load at a first set of one or more time instances and the second supply category being supply in excess of the energy consumed by the target load at a second set of one or more time instances, wherein the first set of one or more time instances includes the second set of one or more time instances.

### FIELD OF INVENTION

The present invention relates broadly to a method and system for creating information representing a state of an electrical power distribution system, and specifically to a method and system for converting production units and units into exchangeable assets using categorisation.

### BACKGROUND

Virtual systems for renewable power provide for energy allocations of electrical power generated from distributed generators connected on an electrical power network. These generators are frequently sized according to a space constrained region, and as such, the electrical potential capacity of such generators is selected through constraints of their physical origin rather than according to the optimised electrical power production capacity in respect of any particular load consuming electrical power.

In addition, consumers are becoming more frequently interested in accepting clean electrical power from distributed generators as a resource for obtaining their electrical power to server there load volume. Physical supply scenarios for distributed generation has advanced to a point where electrical power from a distributed generator off-site is supplied to a consumer even as the generation capacity and intermittent nature of renewable power generation leads to uncertainty in the electrical power output from such distributed generators.

Moreover, in a world where buildings begin to integrate power harvesting devices into their architecture, the distribution network becomes a two-way system of power flows where buildings are not only drawing electrical power in one direction. The complexity on the number of multiple power sources and loads within the connection of the distribution network creates multiple supply scenarios to which consumers could benefit and are nevertheless to date unrealized. For example, WO 2016/032396 (A1) describes a method and system for distributed generation from power harvesting devices at buildings to off-site target loads.

In such a scenario, the potential power capacity of the electrical generator, often being an aggregate of generators, in respect to the host load at the installation of the facility and the off-site targeted load desiring to be supplied by electrical power from the distributed generator(s) are often unmatched. This leads to confusion as to the potential capacity of generation and load consumption of the electrical power in terms of the mismatch of electrical production and consumption, as well as the manner in which power is introduced in the power distribution network due to the newly introduced complexity of two-way power flows due to distributed generation.

Power consumed on-site may be associated with a distributed generator physically connected to the reticulation system of a circuit connected to the electrical mains power network. According to the size of the space available for installation of the distributed generator, there can be a physical load import component as well as a physical load export component which can be measured across a bidirectional meter installed at the building. The electrical power produced from the distributed generator may alternatively be viewed from a virtual allocation through the entire contiguous electrical power network to other loads. In proportion to any other load on the contiguous electrical power network, the offsite power supply to those loads may be of various volumes in respect of those loads.

Confusion may thus arise wherein the instantaneous electrical power production of the distributed generator may be more or less than the instantaneous electrical load. There may be an amount of power supplied off-site to the load which is less that the actual load volume, or greater than the actual load volume. To make matters more confusing, the integration of electrical supply and demand from such off-site distribution systems may be integrated over many “instantaneous” period of supply and demand within a particular billing cycle, for example.

Embodiments of the present invention seek to address one or more of the above challenges.

### SUMMARY

In accordance with a first aspect of the present invention there is provided a method of creating information representing a state of an electrical power distribution system for supply of energy from one or more distributed generators to a target load, the method comprising the steps of determining target consumption data representing energy consumed by the target load; and creating capacity-resolved supply data representing energy supplied to the target load from the one or more distributed generators; wherein creating the capacity-resolved supply data comprises categorizing the energy supplied to the target load into at least one of a first supply category and a second supply category, the first supply category being supply equal to or less than the energy consumed by the target load at a first set of one or more time instances and the second supply category being supply in excess of the energy consumed by the target load at a second set of one or more time instances, wherein the first set of one or more time instances includes the second set of one or more time instances.

In accordance with a second aspect of the present invention there is provided a system for creating information representing a state of an electrical power distribution system for supply of energy from one or more distributed generators to a target load, the system comprising a determination unit configured to receive target consumption data representing energy consumed by the target load; and a processing unit configured to create capacity-resolved supply data representing energy supplied to the target load from the one or more distributed generators; wherein the processing unit is configured to categorize the energy supplied to the target load into at least one of a first supply category and a second supply category, the first supply category being supply equal to or less than the energy consumed by the target load at a first set of one or more time instances and the second supply category being supply in excess of the energy consumed by the target load at a second set of one or more time instances, wherein the first set of one or more time instances includes the second set of one or more time instances.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 shows a schematic drawing illustrating a series of electrical loads and generators with point of common coupling to an electrical power distribution system according to an example embodiment.

FIG. 2 shows a schematic graph illustrating a capacity-resolved set of generators and loads according to an example embodiment.

FIG. 3 shows a schematic graph illustrating a time-resolved aspect of capacity allocation according to an example embodiment.

FIG. 4 shows a schematic graph illustrating a time-resolved aspect of capacity allocation according to an example embodiment.

FIG. 5 shows a schematic graph illustrating a time-resolved aspect of capacity allocation according to an example embodiment.

FIG. 6 shows a schematic graph illustrating a representation of power supply to a target load on a distribution network, according to an example embodiment.

FIG. 7 shows a flow-chart illustrating a method of creating information representing a state of an electrical power distribution system for supply of energy from one or more distributed generators to a target load, according to an example embodiment.

FIG. 8 shows a schematic drawing illustrating a system for creating information representing a state of an electrical power distribution system for supply of energy from one or more distributed generators to a target load, according to an example embodiment.

### DETAILED DESCRIPTION

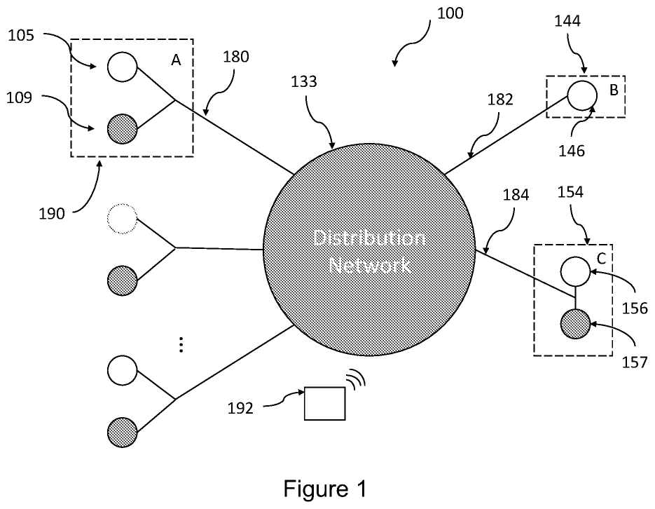

FIG. 1 illustrates an electrical power distribution system 100 for transmission and/or distribution of electrical power (hereafter referred to as distribution, but not limited only to distribution and including transmission) integrated with various electrical generators e.g. 109 producing electrical power and electrical loads e.g. 105 consuming electrical power. A point of coupling (POC) of a pair of generators 109 and loads 105 within Circuit A 190 is integrated to the electrical power distribution system 100 with a service cable 180 for the conductor reticulation system (i.e. Circuit A 190) connected to the electrical distribution network 133. Any set of generators and loads of a common circuit e.g. Circuit A 190 can be connected to the electrical distribution network 133 such that power may be drawn to loads or fed to the electrical distribution network through the service cable connection 180. It is noted that consumption and/or generation data may include, but is not limited to, metered actual consumption and/or generation, estimated consumption and/or generation, forecast consumption and/or generation, or indirectly measured consumption and/or generation.

Circuit A 190 generalises a reticulation electrical wiring incorporating both electrical loads and generators. Circuit B 144 generalises a reticulation electrical wiring incorporating a target load 146 taking supply of power through electrical power distribution system 100. A POC service cable 182 connects the network 133 with the target load 146 in Circuit B 144. Circuit C 154 generalises a reticulation electrical wiring incorporating a target load 156 taking supply of power through electrical power distribution system 100 and through an embedded generator (EG) 157 connected within Circuit C 154. A POC service cable 184 connects the network 133 with the target load 156 and EG 157 in Circuit C.

It would be advantageous to record and represent the state of the electrical power distribution system 100 at any time and over a series of operating periods. In particular, the categorization of production and consumption from various generators e.g. 109, and loads e.g. 105, respectively, have been recognized by the inventors to have a capacity resolution in regard the volume of power produced or consumed in the particular common circuit e.g. Circuit A 190. More specifically, the direction of current flow on the POC service cable 180 connecting the common Circuit A 190 to the electrical distribution network 133 provides information in regard the kinds of electrical generation and loads among the distributed generators supplying power in respect of electricity usage at a target load (e.g. 146 or 156) connected on the same distribution network 133, and the state of the distribution of generated electrical power with respect to a target load through the whole electrical power distribution system 100.

For example, when electrical power generated at generator 109 is larger than the electrical load 105 at a time instance, a current flow in the direction of the electrical distribution network 133 at the POC service cable 180 is recorded as the state of the system according to an example embodiment. On the other hand, when electrical power generated at generator 109 is lower than the electrical load 105 a current flow from the direction of the electrical distribution network 133 at the POC service cable 180 is recorded as the state of the electrical power distribution system, according to an example embodiment.

Power supply to a target load e.g. 146, 156 can be considered to be transacted through electrical power distribution system 100 in regard the supply and demand characteristics at a time instance, or over a series of time instances, and not limited to power supply transacted according to the electrical current flows which are determined through resistivity of the entire circuit of the electrical power distribution system 100 at a time instance. As such, the state of the electrical power distribution system at any time instance representing the supply and demand characteristics resulting from various states of distributed generators and consumer loads, in respect of the target load contracting supply, according to an example embodiment advantageously provides information in respect of supply and demand on the electrical power distribution system 100 and transaction of electrical generation and supply on the electrical power distribution system. The state of the electrical power distribution system 100 may be determined by a server 192 of the electrical power distribution system 100.

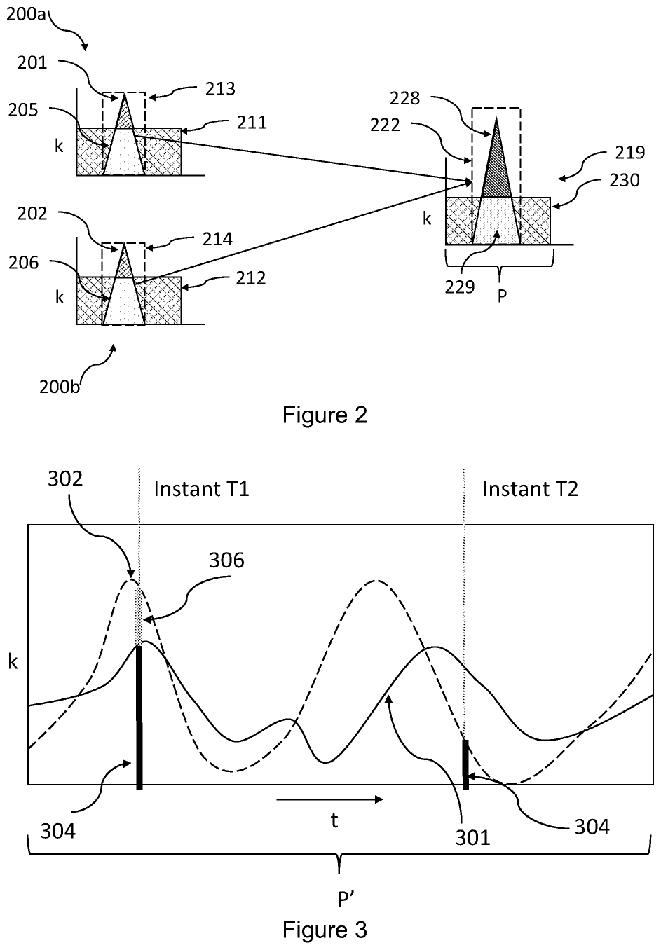

FIG. 2 shows schematic graphs illustrating a capacity-resolved set of generator and load pairs (compare Circuit A 190 in FIG. 1), hereinafter also referred to as distributed generators 200a, 200b comprising an example generator, with associated capacity-resolved production data 213, 214, and an example load, with associated consumption data 211, 212, according to an example embodiment. Target load 219 (compare Circuit B 144 in FIG. 1) is the recipient of electrical power allocated from the distributed generators 200a, 200b transacted on the basis of supply and demand of electrical power on the distribution network (compare 133 in FIG. 1).

Electrical power capacity 201 and electrical power capacity 205 associated with distributed generator 200a categorises potential capacity-resolved supply scenarios in respect of load 211 to the target load 219. Likewise, electrical power capacity 202 and electrical power capacity 206 associated with distributed generator 200b categorises potential capacity-resolved supply scenarios in respect of load 212 to the target load 219.

Capacity-resolved production data 213, 214 representing energy produced from the distributed generator 200a, 200b is created according to an example embodiment, wherein generating the capacity-resolved production data 213, 214 comprises categorizing the energy produced into one of a first production category 205, 206 and a second supply category 201, 202.

The first production category 205, 206 is supply equal to or less than the energy consumed by the respective loads of the distributed generator 200a, 200b at a first set of one or more time instances (compare respective consumption data 211, 212 of the loads). The second production category 201, 202 is production in excess of the energy consumed by the respective loads at a second set of one or more time instances (compare respective consumption data 211, 212 of the loads), wherein the first set of one or more time instances includes the second set of one or more time instances.

The state of the electrical power distribution system characterized by the instantaneous capacities of various generation (e.g. 213 and 214) and load (e.g. 211, 212) components provides information on the direction of power flows on the reticulation circuits (e.g. Circuit A 190 in FIG. 1) in respect of a target load consumption, as well as the state of supply and demand of electrical power on the distribution network (compare distribution network 133 in FIG. 1). As mentioned before, it may be advantageous to provide for transaction of power generation and consumption in respect of supply and demand through a conductor, instead of transaction dependent on physical origin of power or the current flow and/or resistivity of the conducting medium at a time, specifically including power production categorised under a state of a current flowing “into” the electrical distribution network, i.e. second production category 201, 202, and under a state of a current flowing “from” the electrical distribution network, i.e. first production category 205, 206)

Capacity-resolved supply data 222 representing energy supplied to the target load 219 from the distributed generators 200a, 200b is created according to an example embodiment, wherein creating the capacity-resolved supply data 222 comprises categorizing the energy supplied to the target load 219 into one of a first supply category 229 and a second supply category 228.

The first supply category 229 is supply equal to or less than the energy consumed by the target load 219 at a first set of one or more time instances (compare target consumption data 230). The second supply category 228 is supply in excess of the energy consumed by the target load 219 at a second set of one or more time instances (compare target consumption data 230), wherein the first set of one or more time instances includes the second set of one or more time instances.

In an example embodiment, creating the capacity-resolved supply data 222 from the capacity resolved production data 213, 214 of the distributed generators 200a, 200b comprises matching a total amount of supplied energy of the first and second supply categories 229, 228 over a supply period P to an integral amount of energy consumed by the target load 219 over the same supply period P (compare target consumption data 230). Creating the capacity-resolved supply data 222 may also account for embedded generation (compare circuit C 154 in FIG. 1) such that the target load 230 receives some power through an embedded distributed generator within its own reticulation wiring system.

In an example embodiment, the capacity-resolved supply data 222 comprises produced energy of both of the first and second production categories. However, it is noted that in other embodiments, the capacity-resolved supply data 222 may comprise produced energy of the first production category 205, 206 only, or of the second production category 201, 202 only, or a combination thereof according to the availability or consumer selected requirements.

FIG. 3 shows a schematic graph illustrating a time-resolved aspect of capacity allocation over a period P′ according to an example embodiment. Such a representation may result from the power generation and consumption on a representative Circuit A 190. Consumption load data 301 representing energy consumed by an on-site load in the circuit is provided. Generating capacity-resolved production data 302 representing energy produced by a generator of the circuit comprises categorizing the energy into one of a first production category 304 and a second production category 306 at specific time instances.

The first production category 304 is supply equal to or less than the energy consumed by the load of the circuit at a first set of one or more time instances e.g. T1, T2. The second supply category 306 is supply in excess of the energy consumed by the load of the circuit at a second set of one or more time instances e.g. T1, wherein the first set of one or more time instances e.g. T1, T2 includes the second set of one or more time instances e.g. T1. See similarly, the description of creating capacity-resolved production data described with reference to FIG. 2 above.

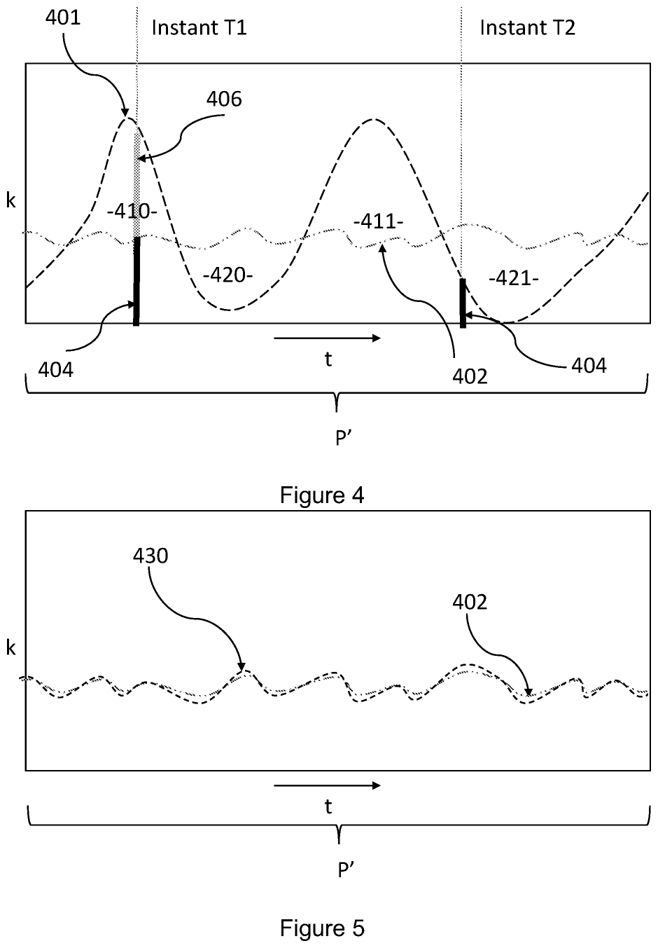

FIG. 4 shows a schematic graph illustrating a time-resolved aspect of capacity allocation according to an example embodiment. A target load (compare target load 146, 156 or Circuits B 144 and C 154, respectively, in FIG. 1) may obtain power made available on the power distribution network through any of one or more distributed generators (compare Circuit A 190 in FIG. 1). In this graph a single distributed generator is selected to provide an amount of generation made available through an electrical distribution network is for ease of representation, while it is understood that multiple distributed generators are able to supply to a target load on the electrical power distribution system. Such a representation may result from the consumption on a representative Circuit B 144 (FIG. 1). Moreover, the potential embedded generator (compare representative Circuit C 154 in FIG. 1) is ignored in this representation.

Capacity-resolved supply data 401 is created. Target load consumption data 402 is provided. The creating of the capacity-resolved supply data 401 comprises categorizing the energy supply into one of a first supply category 404 and a second supply category 406. The first supply category 404 is supply equal to or less than the energy consumed by the target load, according to the consumption data 402, at a first set of one or more time instances e.g. T1, T2. The second supply category 406 is supply in excess of the energy consumed by the target load, according to the consumption data 402, at a second set of one or more time instances e.g. T1, wherein the first set of one or more time instances e.g. T1, T2 includes the second set of one or more time instances e.g. T1.

In an example embodiment, the integral amounts of energy supplied over the period P′ (i.e. integral under the curve representing the time-resolved supply data 401) and energy consumed by the target load of the circuit over the period P′ (i.e. integral under the curve representing the time-resolved consumption data 402) may be advantageously matched, so that substantially 100% of the consumed energy at the target load is in effect provided by the associated one or more circuits A 190 (FIG. 1) distributed generation. However, it is noted that the ratio of the integral amounts can be chosen based on various energy product arrangements for the target load in different embodiments, such as providing an agreed portion such as, but not limited to, 80%, 60% or 40% of the energy consumed over the period P′ from the distributed generator.

As can be seen from FIG. 4, in such a representation, the supply condition of the electrical power distribution system for supply of energy from the distributed generator(s) to the target load may not be readily appreciated by e.g. the consumer. In a preferred embodiment, the generating of the time-resolved supply data comprises time-shifting one or more portions 410, 411 of the supplied energy of the second category 406 according to the “raw” supply data 401 to time instances where the supplied energy is only of the first category 404 and is less than the target load consumption, e.g. in time instances generally indicated at numerals 420, 421, while substantially maintaining the total amount of energy supplied to the target load over the supply period P′ according to the raw supply data 401. Advantageously, according to such an embodiment, the profile of the modified time-resolved supply data 430 over the supply period P′ substantially matches the profile of the time-resolved consumption data 402 over the supply period P′, as shown in FIG. 5. In such a representation, the supply condition of the electrical power distribution system for supply of energy from the distributed generator(s) to the target load can thus be readily appreciated by e.g. the consumer.

Moreover, the supply condition can be advantageously categorized for the target load user by representing the state of the electrical power distribution system at various times according to the capacity- and time-resolved generation and supply according to example embodiments, as illustrated in Table 1 and Table 2 below. Equally, the incorporation of an embedded generator (compare generator 157 of Circuit C 154 in FIG. 1) can also be implemented to categorise an additional kind of supply, being representation of electrical production within the circuit of the target load and supplied to that load. Specifically, in this scenario, any other electricity consumed by the target load from the distributed generators may be characterized using the First and Second production category and the First and Second Supply Category, as also illustrated in Table 1 and Table 2, respectively. In Table 1 and Table 2, L denotes the absolute energy consumed by the load.

By utilizing this categorization according to an example embodiment, converted electrical supply and production units can preferably be issued as cryptographic assets or “tokens”, for example, and may be implemented in a trading system. A blockchain representation of the different categorized tokens may be used to provide for exchange of the tokens. Smart Contracts development may be implemented with a blockchain system, wherein the representation of categorized production or supply utilizing capacity-resolutions as described/defined according to example embodiments may be utilised to quantify the conversion into cryptographic assets (“tokenization”) of electrical power supplied, or for implementation within a smart contract settling generation and supply of power over a power distribution network using any one of various prioritizations of electrical supply to a target load involving such capacity-resolution categorisation. For description of examples of prioritisation systems and methods, reference is made to WO 2016/064341 A1 and WO 2017/217933 A1, the contents of which are hereby incorporated by cross-reference.

TABLE 1

| | Network | | | Network |
|---|---|---|---|---|
| Distributed | State | | Embedded | State |
| Generator | POC at | Target | Generator | POC to |
| (DG) | Producer | Load | (EG) | Target Load |
| First Production Category: | From | First Supply Category: | Y | IF EG > L @time |
| production in excess of | DG | supply equal to or | | instance = T, |
| consumption at one or more | to | less than the | | From Target Load |
| on-site loads of the | Network | energy consumed by | | to Network at T, |
| distributed generator | | the target load | | ELSE from Network |
| | | (exclusive of energy | | to Target Load |
| | | supplied from EG) | | |
| First Production Category: | From | First Supply Category: | N | From |
| production in excess of | DG | supply equal to or | | Network |
| consumption at one or more | to | less than the | | to |
| on-site loads of the | Network | energy consumed by | | Target |
| distributed generator | | the target load | | Load |
| First Production Category: | From | Second Supply | Y | IF EG > L @time |
| production in excess of | DG | Category: supply | | instance = T, |
| consumption at one or more | to | in excess of the | | From Target Load |
| loads of the distributed | Network | energy consumed by | | to Network at T, |
| generator | | the target load | | ELSE from Network |
| | | (exclusive of energy | | to Target Load |
| | | supplied from EG) | | |
| First Production Category: | From | Second Supply | N | From |
| production in excess of | DG | Category: supply | | Network |
| consumption at one or more | to | in excess of the | | to |
| loads of the distributed | Network | energy consumed by | | Target |
| generator | | the target load | | Load |

Moreover, users of the generation and supply system may be able to obtain enhanced information about the nature of the supply contracts. They may be able to utilise representations like visual representations or symbolic representations derived from the production and supply category system and method according to an example embodiment to understand the state of the electrical power distribution system during periods of power generation, usage and supply.

TABLE 2

| | Network | | | Network |
|---|---|---|---|---|
| Distributed | State | | Embedded | State |
| Generator | POC at | Target | Generater | POC to |
| (DG) | Producer | Load | (EG) | Target Load |
| Second Production Category: | From | First Supply Category: | Y | IF EG > L @time |
| production equal to or less | Network | supply equal to or less | | instance = T, From |
| than consumption at the one | to | than the energy | | Target Load to |
| or more loads of the | DG | consumed by the target | | Network at T, ELSE |
| distributed generator | | load (exclusive of | | from Network to |
| | | energy supplied from | | Target Load |
| | | EG) | | |
| Second Production Category: | From | First Supply Category: | N | From |
| production equal to or less | Network | supply equal to or less | | Network |
| than consumption at the one | to | than the energy | | to |
| or more loads of the | DG | consumed by the target | | Target |
| distributed generator | | load | | Load |
| Second Production Category: | From | Second Supply | Y | IF EG > L @time |
| production equal to or less | Network | Category: supply in | | instance = T, From |
| than consumption at the one | to | excess of the energy | | Target Load to |
| or more loads of the | DG | consumed by the target | | Network at T, ELSE |
| distributed generator | | load (exclusive of | | from Network to |
| | | energy supplied from | | Target Load |
| | | EG) | | |
| Second Production Category: | From | Second Supply | N | From |
| production equal to or less | Network | Category: supply in | | Network |
| than consumption at the one | to | excess of the energy | | to |
| or more loads of the | DG | consumed by the target | | Target |
| distributed generator | | load | | Load |

Advantageously, this categorical representation system and method according to anexample embodiment allows for users to perform more suitable transactions over the electrical power distribution network. For example, by categorizing production and/or supply information as in Table 1 and/or Table 2 above, various smart contracts may be implemented for transaction of electrical generation and consumption over a power grid network. For example, different users can obtain a portion of produced power for a target load dependent on the capacity-resolved categorization, according to an example embodiment. In another example embodiment, a user may obtain half (or another amount) of the first production category for supply to the on-site load, while the remaining electrical generation of the first production category may be supplied to a target load. Thereafter, any electrical generation of the second production category could be similarly split (for example in half, or thirds) among target loads and the specific on-site load of the circuit in which the distributed generator resides.

Prioritisation systems for power generation and supply may be implemented in an example embodiment. For example, firstly, production of a first production category may be made available to a specific target load, and thereafter production of a second production category may be made available to a different target load.

Advantageously, by way of prioritization, embedded generation can be assumed to be supplied to a consumer load itself, wherein any remaining portion of unsupplied power can be transacted through one of a first production category or second production category, for supply of a first supply category or a second supply category to another target load.

Various combinations of prioritization may be implemented with multiple users, according to example embodiments.

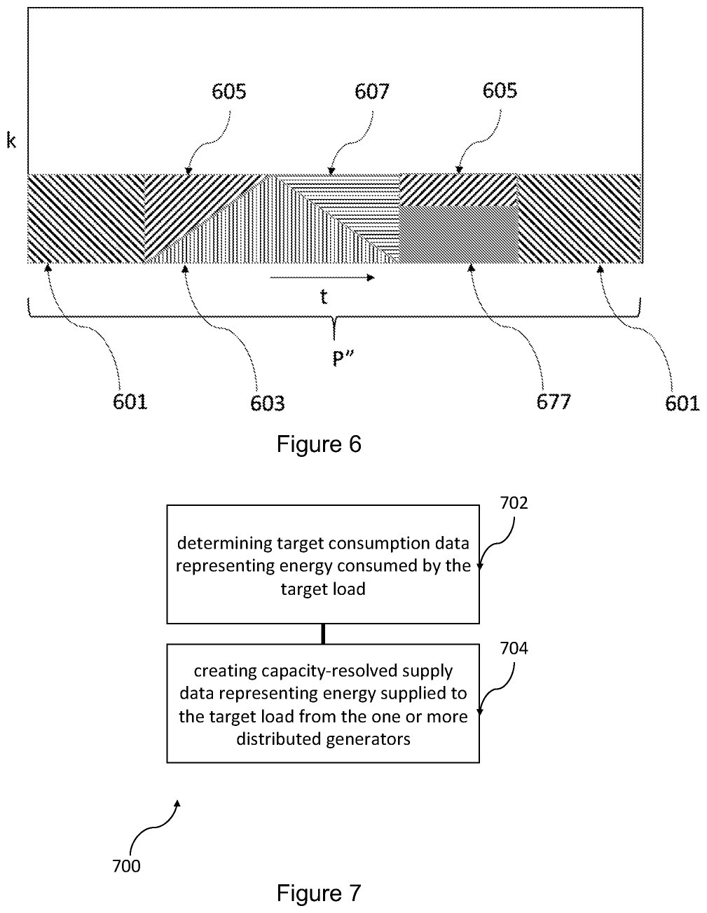

FIG. 6 illustrates an embodiment of a representation of power supply to a target load on a distribution network. For ease of illustration, the target load is assumed to be a flat capacity load over a time period P″, as illustrated by the constant k value across the time period P″. Embedded Generation 677 is illustrated as a capacity-resolved supply for a portion of the time period P″. Remaining power supplied through distributed generation is categorized, distinguishing various kinds of production and supply data by illustration of capacity-resolved information with patterns. A first or second production category with a first or second supply category are advantageously clearly observable with different representation.

Power of a first production category supplied with a first supply category 601 utilised a pattern of diagonal lines slanting right. Power of a first production category supplied with a second supply category 603 utilised a pattern with vertical lines. Power of a second production category supplied with a first supply category 605 utilised a pattern of diagonal lines slanting left. Power of a second production category supplied with a second supply category 607 utilised a pattern of horizontal lines. Such representation of power generation and supply are not limited to this embodiment. Colors, text indicators, certification serial numbers, or other distinguishing data means may also be utilised to demonstrate the characteristics of such power transactions of a power distribution network in example embodiments.

Advantageously, the categorization of supply and production according to example embodiments facilitates providing information about transfers of energy, in particular information about different types of energy transactions between production and consumption with overlapping time periods, according to an example embodiment.

A labelling convention may be implemented according to an example embodiment, as listed below. The volume of power of a production category transacted against a particular supply category may then be recorded as an amount of the associated transaction type.
Type 1 Production (T1P) transact to Type 1 Supply (TIS) being represented with the label T1PT1S.
Type 1 Production (TIP) transact to Type 2 Supply (T2S) represented with the label T1PT2S.
Type 2 Production (T2P) transact to Type 1 Supply (T1S) represented with the label T2PT1S.
Type 2 Production (T2P) transact to Type 2 Supply (T2S) represented with the label T2PT2S.

Based on the different types of transaction, conversion into digital assets can be performed, for example a single token value (e.g. common token E) can be implemented, wherein the tokenization may take on a scalar value according to the kind of transaction such that a natural economic prioritization occurs:

E=T1PT1S×Conversion multiple f(P,S)

E=T1PT2S×Conversion multiple f(P,S)

E=T2PT1S×Conversion multiple f(P,S)

E=T2PT2S×Conversion multiple f(P,S)

In the above scalar value, P and S mean production or supply while f(P,S) is a function of P and S allowing for conversion of the various kinds of transactions into the common scalar token E. Thus, a conversion into a scalar E allows for an economic prioritisation to be imposed by a regulatory party, such as an Independent Systems Operator (ISO), or as designed to optimize the electrical power flows on a power distribution network.

FIG. 7 shows a flow-chart 700 illustrating a method of creating information representing a state of an electrical power distribution system for supply of energy from one or more distributed generators to a target load, according to an example embodiment. At step 702, target consumption data representing energy consumed by the target load is determined. At step 704, capacity-resolved supply data representing energy supplied to the target load from the one or more distributed generators is created, wherein creating the capacity-resolved supply data comprises categorizing the energy supplied to the target load into at least one of a first supply category and a second supply category, the first supply category being supply equal to or less than the energy consumed by the target load at a first set of one or more time instances and the second supply category being supply in excess of the energy consumed by the target load at a second set of one or more time instances, wherein the first set of one or more time instances includes the second set of one or more time instances.

Creating the capacity-resolved supply data may comprise matching a total amount of supplied energy of the first and second supply categories over a defined supply period to an integral amount of energy consumed by the target load over the defined supply period. Creating the capacity-resolved supply data may comprise shifting at least a portion of the supplied energy of the second category at one or more of the second set of time instances to one or more of the first set of time instances, while substantially maintaining the total amount of energy supplied to the target load over the defined supply period, such that a time-profile of the capacity-supply data over the defined supply period substantially matches a time-profile of the consumption data over the defined supply period.

The method may further comprise creating capacity-resolved production data, wherein creating the capacity-resolved production data comprises categorizing the energy produced by the one or more distributed generators into one of a first production category and a second production category, the first production category being production in excess of consumption at one or more on-site loads in respective reticulation circuits comprising the one or more distributed generators at a third set of one or more time-instances and the second production category being production equal to or less than the consumption at the one or more on-site loads at a fourth set of one or more time-instances, wherein the fourth set of one or more time instances includes the third set of one or more time instances. The capacity-resolved supply data may represent produced energy of one or both of the first and second production categories at the third and fourth set of time instances, respectively, over a defined production period. The capacity-resolved supply data may represent one or more transactions of produced energy of the first or second production category to meet the supply of the first or second supply category. The method may comprise identifying different transaction types comprising one or more of a group consisting of a first transaction type being produced energy of the first production category to meet supply of the first supply category, a second transaction type being produced energy of the first production category to meet supply of the second supply category, a third transaction type being produced energy of the second production category to meet supply of the first supply category, and a fourth transaction type being produced energy of the second production category to meet supply of the second supply category. The method may comprise conversion of the one or more transactions into a digital asset using tokenization, wherein the tokenization comprises a scalar value according to the type of transaction. The token may comprise cryptographic token for a blockchain system.

The method may further comprise displaying the capacity-resolved supply data in a manner such that each supply category and/or each production category is distinguishable. The capacity-resolved supply data may be overlaid with the target consumption data.

The consumption data is exclusive of energy supplied to the target load from one or more embedded generators in a reticulation circuit comprising the target load at a firth set of one or more time instances. The method may further comprise categorising the energy supplied by the one or more embedded generators into different production categories depending on a comparison with the energy consumed by the target load at the fifth set of one or more time instances. The method may further comprise shifting, as a priority, energy supplied by the one or more embedded generators in excess of the energy consumed by the target load at the fifth set of one or more time instances to selected one or more the first set of one or more time instances at which where the energy of the first supply category is less than the energy consumed by the target load, and thereafter making any remaining energy supplied by the one or more embedded generators available for supply to a different target load within the electrical power distribution system.

The created information may represent the states of current flow direction at any one or more point of couplings of the electrical power distribution system.

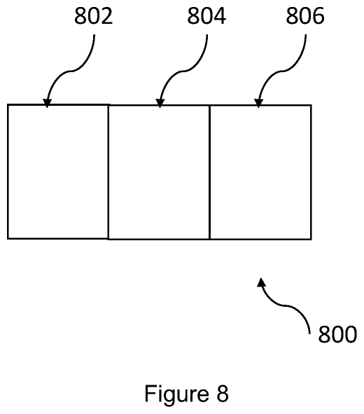

FIG. 8 shows a schematic drawing illustrating a system 800 for creating information representing a state of an electrical power distribution system for supply of energy from one or more distributed generators to a target load, according to an example embodiment. The system 800 comprises a determination unit 802 configured to determine target consumption data representing energy consumed by the target load, and a processing unit 804 configured to create capacity-resolved supply data representing energy supplied to the target load from the one or more distributed generators, wherein creating the capacity-resolved supply data comprises categorizing the energy supplied to the target load into at least one of a first supply category and a second supply category, the first supply category being supply equal to or less than the energy consumed by the target load at a first set of one or more time instances and the second supply category being supply in excess of the energy consumed by the target load at a second set of one or more time instances, wherein the first set of one or more time instances includes the second set of one or more time instances.

Creating the capacity-resolved supply data may comprise matching a total amount of supplied energy of the first and second supply categories over a defined supply period to an integral amount of energy consumed by the target load over the defined supply period. Creating the capacity-resolved supply data may comprise shifting at least a portion of the supplied energy of the second category at one or more of the second set of time instances to one or more of the first set of time instances, while substantially maintaining the total amount of energy supplied to the target load over the defined supply period, such that a time-profile of the capacity-supply data over the defined supply period substantially matches a time-profile of the consumption data over the defined supply period.

The processing unit 804 may be further configured to create capacity-resolved production data, wherein creating the capacity-resolved production data comprises categorizing the energy produced by the one or more distributed generators into one of a first production category and a second production category, the first production category being production in excess of consumption at one or more on-site loads in respective reticulation circuits comprising the one or more distributed generators at a third set of one or more time-instances and the second production category being production equal to or less than the consumption at the one or more on-site loads at a fourth set of one or more time-instances, wherein the fourth set of one or more time instances includes the third set of one or more time instances. The capacity-resolved supply data may represent produced energy of one or both of the first and second production categories at the third and fourth set of time instances, respectively, over a defined production period. The capacity-resolved supply data may represent one or more transactions of produced energy of the first or second production category to meet the supply of the first or second supply category. The processing unit 804 may be further configured to identify different transaction types comprising one or more of a group consisting of a first transaction type being produced energy of the first production category to meet supply of the first supply category, a second transaction type being produced energy of the first production category to meet supply of the second supply category, a third transaction type being produced energy of the second production category to meet supply of the first supply category, and a fourth transaction type being produced energy of the second production category to meet supply of the second supply category. The processing unit 804 is further configured to convert the one or more transactions into a digital asset using tokenization, wherein the tokenization comprises a scalar value according to the type of transaction. The token may comprise a cryptographic token for a blockchain system.

The system may further comprise a display 806 configured to display the capacity-resolved supply data in a manner such that each supply category and/or each production category is distinguishable. The display 806 may be configured to overlay the capacity-resolved supply data with the target consumption data.

The consumption data may be exclusive of energy supplied to the target load from one or more embedded generators in a reticulation circuit comprising the target load at a firth set of one or more time instances. The processing unit 804 may be further configured to categorise the energy supplied by the one or more embedded generators into different production categories depending on a comparison with the energy consumed by the target load at the fifth set of one or more time instances. The processing unit 804 may be further configured to shift, as a priority, energy supplied by the one or more embedded generators in excess of the energy consumed by the target load at the fifth set of one or more time instances to selected one or more the first set of one or more time instances at which where the energy of the first supply category is less than the energy consumed by the target load, and thereafter making any remaining energy supplied by the one or more embedded generators available for supply to a different target load within the electrical power distribution system.

The created information may represent the states of current flow direction at any one or more point of couplings of the electrical power distribution system.

The various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the internet and/or other computer networks via one or more data transfer protocols (e.g., HTTP, FTP, SMTP, etc.). When received within a computer system via one or more computer-readable media, such data and/or instruction-based expressions of components and/or processes under the system described may be processed by a processing entity (e.g., one or more processors) within the computer system in conjunction with execution of one or more other computer programs.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course, the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

1. A method of creating information representing a state of an electrical power distribution system for supply of energy from one or more distributed generators to a target load, the method comprising:
determining target consumption data representing energy consumed by the target load; and
creating one of:
capacity-resolved supply data representing energy supplied to the target load from the one or more distributed generators, wherein creating the capacity-resolved supply data comprises categorizing the energy supplied to the target load into at least one of a rust supply category and a second supply category, the first supply category being supply equal to or less than the energy consumed by the target load at a first set of one or more time instances and the second supply category being supply in excess of the energy consumed by the target load at a second set of one or more time instances, wherein the first set of one or more time instances includes the second set of one or more time instances; and
said capacity-resolved supply data and capacity-resolved production data, wherein creating the capacity-resolved production data comprises categorizing the energy produced by the one or more distributed generators into one of a first production category and a second production category, the first production category being production in excess of consumption at one or more on-site loads in respective reticulation circuits comprising the one or more distributed generators at a third set of one or more time instances and the second production category being production equal to or less than the consumption at the one or more on-site loads at a fourth set of one or more time instances, wherein the fourth set of one or more time instances includes the third set of one or more time instances.

2. The method of claim 1, wherein creating the capacity-resolved supply data comprises matching a total amount of supplied energy of the first and second supply categories over a defined supply period to an integral amount of energy consumed by the target load over the defined supply period.

3. The method of claim 2, wherein creating the capacity-resolved supply data comprises shifting at least a portion of the supplied energy of the second category at one or more of the second set of time instances to one or more of the first set of time instances, while substantially maintaining the total amount of energy supplied to the target load over the defined supply period, such that a time-profile of the capacity-supply data over the defined supply period substantially matches a time-profile of the consumption data over the defined supply period.

4. (canceled)

5. The method of claim 1, wherein the capacity-resolved supply data represents produced energy of one or both of the first and second production categories at the third and fourth set of time instances, respectively, over a defined production period.

6. The method of claim 5, wherein the capacity-resolved supply data represents one or more transactions of produced energy of the first or second production category to meet the supply of the first or second supply category.

7. The method of claim 6, comprising identifying different transaction types comprising one or more of a group consisting of a first transaction type being produced energy of the first production category to meet supply of the first supply category, a second transaction type being produced energy of the first production category to meet supply of the second supply category, a third transaction type being produced energy of the second production category to meet supply of the first supply category, and a fourth transaction type being produced energy of the second production category to meet supply of the second supply category.

8. The method of claim 7, comprising conversion of the one or more transactions into a digital asset using tokenization, wherein the tokenization comprises a scalar value according to the type of transaction;
wherein the token may comprise a cryptographic token for a blockchain system.

9. (canceled)

10. The method of claim 5, further comprising displaying the capacity-resolved supply data in a manner such that each supply category and/or each production category is distinguishable and wherein the capacity-resolved supply data may be overlaid with the target consumption data.

11. (canceled)

12. The method of claim 1, wherein the consumption data are exclusive of energy supplied to the target load from one or more embedded generators in a reticulation circuit comprising the target load at a firth set of one or more time instances; or
wherein the created information represents the states of current flow direction at any one or more point of couplings of the electrical power distribution system.

13. The method of claim 10, further comprising categorising the energy supplied by the one or more embedded generators into different production categories depending on a comparison with the energy consumed by the target load at the fifth set of one or more time instances; and
further comprising shifting, as a priority, energy supplied by the one or more embedded generators in excess of the energy consumed by the target load at the fifth set of one or more time instances to selected one or more the first set of one or more time instances at which where the energy of the first supply category is less than the energy consumed by the target load, and thereafter making any remaining energy supplied by the one or more embedded generators available for supply to a different target load within the electrical power distribution system.

14. (canceled)

15. (canceled)

16. A system for creating information representing a state of an electrical power distribution system for supply of energy from one or more distributed generators to a target load, the system comprising:
a determination unit configured to determine target consumption data representing energy consumed by the target load; and
a processing unit configured to create one of:
capacity-resolved supply data representing energy supplied to the target load from the one or more distributed generators, wherein creating the capacity-resolved supply data comprises categorizing the energy supplied to the target load into at least one of a first supply category and a second supply category, the first supply category being supply equal to or less than the energy consumed by the target load at a first set of one or more time instances and the second supply category being supply in excess of the energy consumed by the target load at a second set of one or more time instances, wherein the first set of one or more time instances includes the second set of one or more time instances; and
said capacity-resolved supply data and capacity-resolved production data, wherein creating the capacity-resolved production data comprises categorizing the energy produced by the one or more distributed generators into one of a first production category and a second production category, the first production category being production in excess of consumption at one or more on-site loads in respective reticulation circuits comprising the one or more distributed generators at a third set of one or more time instances and the second production category being production equal to or less than the consumption at the one or more on-site loads at a fourth set of one or more time instances, wherein the fourth set of one or more time instances includes the third set of one or more time instances.

17. The system of claim 16, wherein creating the capacity-resolved supply data comprises matching a total amount of supplied energy of the first and second supply categories over a defined supply period to an integral amount of energy consumed by the target load over the defined supply period.

18. The system of claim 17, wherein creating the capacity-resolved supply data comprises shifting at least a portion of the supplied energy of the second category at one or more of the second set of time instances to one or more of the first set of time instances, while substantially maintaining the total amount of energy supplied to the target load over the defined supply period, such that a time-profile of the capacity-supply data over the defined supply period substantially matches a time-profile of the consumption data over the defined supply period.

19. (canceled)

20. The system of claim 16, wherein the capacity-resolved supply data represents produced energy of one or both of the first and second production categories at the third and fourth set of time instances, respectively, over a defined production period.

21. The system of claim 20, wherein the capacity-resolved supply data represents one or more transactions of produced energy of the first or second production category to meet the supply of the first or second supply category.

22. The system of claim 21, wherein the processing unit is further configured to identify different transaction types comprising one or more of a group consisting of a first transaction type being produced energy of the first production category to meet supply of the first supply category, a second transaction type being produced energy of the first production category to meet supply of the second supply category, a third transaction type being produced energy of the second production category to meet supply of the first supply category, and a fourth transaction type being produced energy of the second production category to meet supply of the second supply category.

23. The system of claim 22, wherein the processing unit is further configured to convert the one or more transactions into a digital asset using tokenization, wherein the tokenization comprises a scalar value according to the type of transaction;
and wherein the token may comprise a cryptographic token for a blockchain system.

24. (canceled)

25. The system of claim 16, further comprising a display configured to display the capacity-resolved supply data in a manner such that each supply category or each production category is distinguishable; and
wherein the display may be configured to overlay the capacity-resolved supply data with the target consumption data.

26. (canceled)

27. The system of claim 16, wherein the consumption data are is exclusive of energy supplied to the target load from one or more embedded generators in a reticulation circuit comprising the target load at a first firth set of one or more time instances; or
wherein the created information represents the states of current flow direction at any one or more point of couplings of the electrical power distribution system.

28. The system of claim 27, wherein the processing unit is further configured to categorise the energy supplied by the one or more embedded generators into different production categories depending on a comparison with the energy consumed by the target load at the fifth set of one or more time instances and;
wherein the processing unit is further configured to shift, as a priority, energy supplied by the one or more embedded generators in excess of the energy consumed by the target load at the fifth set of one or more time instances to selected one or more the first set of one or more time instances at which where the energy of the first supply category is less than the energy consumed by the target load, and thereafter making any remaining energy supplied by the one or more embedded generators available for supply to a different target load within the electrical power distribution system.

29. (canceled)

30. (canceled)
